(19) United States
(12) Patent Application Publication
(10) Pub. No.: US 2022/0068095 A1
(43) Pub. Date: Mar. 3, 2022

(54) SURVEILLANCE CONTROL DEVICE, SURVEILLANCE SYSTEM, SURVEILLANCE METHOD, AND RECORDING MEDIUM

(71) Applicant: NEC Corporation, Minato-ku, Tokyo (JP)

(72) Inventor: Koichi UEDA, Tokyo (JP)

(73) Assignee: NEC Corporation, Minato-ku, Tokyo (JP)

(21) Appl. No.: 17/298,978

(22) PCT Filed: Dec. 19, 2018
(86) PCT No.: PCT/JP2018/046823

§ 371 Date: Jun. 2, 2021

(51) Int. Cl. G08B 13/196

(52) U.S. Cl. CPC G08B 13/1966; G08B 13/19645; G08B 13/19684; G08B 13/19665

(57) ABSTRACT

The disclosure is receiving first information regarding occurrence of an anomalous event and a position of occurrence of the anomalous event; receiving, through wireless communication, information for identifying one or more portable communication terminals being present in a specific area including the position of occurrence; pinpointing, from among the portable communication terminals and based on the position of occurrence and the information for identifying, a portable communication terminal to which an information provision demand regarding the position of occurrence is to be transmitted; transmitting the information provision demand to the portable communication terminal; and receiving, from the portable communication terminal, second information regarding the occurrence of the anomalous event and the position of occurrence of the anomalous event, the second information being related to the information provision demand.

### TECHNICAL FIELD

The present invention relates to a surveillance control device and the like for collecting information about an event that has occurred.

### BACKGROUND ART

There have been developed surveillance technologies capable of collecting information about anomalous events, such as traffic accidents and natural disasters, when any of such events occurs.

For example, there is a technology by which robots capable of moving and traveling in the event a natural disaster occurs are located in a distributed manner, infrastructure lines are enabled to be connected in an area around the location of the natural disaster being likely to cause disorder, and the state of the natural disaster is acquired via ad-hoc wireless communication (see PTL 1).

There is a technology by which information about a traffic accident is collected from drive recorders or the like in the vehicles that were traveling around the location when the accident occurred (see PTL 2).

Other technologies relating to a surveillance system are disclosed in PTLs 3 to 5.

### CITATION LIST

### Patent Literature

[PTL 1] JP 2015-172791 A
[PTL 2] WO 2018/092536 A
[PTL 3] WO 2014/208575 A
[PTL 4] WO 2016/067610 A
[PTL 5] WO 2016/132734 A

### SUMMARY OF INVENTION

### Technical Problem

However, the technology described in PTL 1 uses robots around the location where a natural disaster has occurred, and is not intended to collect information about the natural disaster from portable communication terminals (smart phones, notebook computers, and the like) carried by people present in the location. Therefore, it is unable to collect very useful information, if any, that people around the location have regarding the natural disaster.

According to the technology described in PTL 2, video pictures recorded in drive recorders in the vehicles traveling around the location when the accident occurred, images taken by persons in the vehicles, text information provided by people who saw the accident, and the like are collected via wireless communication terminals. However, the providers of the information are not identified by the system itself. Therefore, desired information cannot be collected if there is no vehicle, person, or the like who is present around the location and has appropriate information.

The present disclosure has been made in view of the above-described problems, and an object of the present disclosure is to provide a surveillance control device or the like capable of sending instructions to portable communication terminals or the like possessed by people around the location where an anomalous event has occurred and acquiring information about the event.

### Solution to Problem

In view of the above problems, a surveillance control device according to a first aspect of the present disclosure includes:

first information reception means for receiving first information regarding occurrence of an anomalous event and a position of occurrence of the anomalous event;

identifying information reception means for receiving, through wireless communication, information for identifying one or more portable communication terminals being present in a specific area including the position of occurrence;

pinpointing means for pinpointing, from among the portable communication terminals and based on the position of occurrence and the information for identifying, a portable communication terminal to which an information provision demand regarding the position of occurrence is to be transmitted;

transmission means for transmitting the information provision demand to the portable communication terminal; and

second information reception means for receiving, from the portable communication terminal, second information regarding the occurrence of the anomalous event and the position of occurrence of the anomalous event, the second information being related to the information provision demand.

A portable communication terminal according to a second aspect of the present disclosure receives, when an anomalous event occurs and the portable communication terminal is present in a specific area including a position of occurrence of the anomalous event, a request to provide second information regarding the occurrence of the anomalous event and the position of occurrence of the anomalous event, and transmits the second information to a source that has requested to provide the second information.

A surveillance system according to a third aspect of the present disclosure includes:

the surveillance control device described above;

a zone surveillance system that is disposed in each of surveillance zones and is communicably connected to the surveillance control device; and

a portable communication terminal that is held by a customer present in each of the surveillance zones and is capable of taking an image, in which

the zone surveillance system includes at least one of: a surveillance camera; a wireless communication connection point; and an intercom apparatus.

A surveillance method according to a fourth aspect of the present disclosure includes:

receiving first information regarding occurrence of an anomalous event and a position of occurrence of the anomalous event;

receiving, through wireless communication, information for identifying one or more portable communication terminals being present in a specific area including the position of occurrence;

pinpointing, from among the portable communication terminals and based on the position of occurrence and the information for identifying, a portable communication terminal to which an information provision demand regarding the position of occurrence is to be transmitted;

transmitting the information provision demand to the portable communication terminal; and

receiving, from the portable communication terminal, second information regarding the occurrence of the anomalous event and the position of occurrence of the anomalous event, the second information being related to the information provision demand.

A surveillance program according to a fifth aspect of the present disclosure causes a computer to implement:

receiving first information regarding occurrence of an anomalous event and a position of occurrence of the anomalous event;

receiving, through wireless communication, information for identifying one or more portable communication terminals being present in a specific area including the position of occurrence;

pinpointing, from among the portable communication terminals and based on the position of occurrence and the information for identifying, a portable communication terminal to which an information provision demand regarding the position of occurrence is to be transmitted;

transmitting the information provision demand to the portable communication terminal; and

receiving, from the portable communication terminal, second information regarding the occurrence of the anomalous event and the position of occurrence of the anomalous event, the second information being related to the information provision demand.

Note that the surveillance program may be stored in a recording medium.

### Advantageous Effects of Invention

According to the present disclosure, a surveillance control device or the like that sends instructions to portable communication terminals or the like possessed by people in the vicinity of the location at which an anomalous event has occurred to collect information regarding the event can be provided.

### BRIEF DESCRIPTION OF DRAWINGS

FIG. 1 is an example diagram illustrating a configuration of a surveillance system according to a first example embodiment of the present disclosure.

FIG. 2 is an example diagram illustrating an internal configuration of a central control device.

FIG. 3 is an example diagram illustrating an internal configuration of a registered terminal management unit.

FIG. 4 is an example diagram illustrating an internal configuration of an integration surveillance unit.

FIG. 5 is an example diagram illustrating an internal configuration of a portable communication terminal.

FIG. 6 is a sequence diagram illustrating example operations of the surveillance system according to the first example embodiment of the present disclosure.

FIG. 7 is an example diagram illustrating a configuration of a surveillance control device according to a second example embodiment of the present disclosure.

FIG. 8 is an example diagram of a configuration of an information processing device that can be used in the first to third example embodiments.

### EXAMPLE EMBODIMENT

Example embodiments will now be described in detail with reference to the drawings. Throughout the drawings described below, identical or similar reference numerals are given to identical or similar parts. Note that configurations in the example embodiments of the present invention are schematically shown in the drawings. In addition, the example embodiments of the present invention described below are merely examples, and may be modified as appropriate to the extent that they are essentially the same.

### First Example Embodiment

In the event that, in general transport facilities such as an airport, railway station, or bus terminal, or in important infrastructures such as a market or stadium where many people gather, a natural disaster such as a fire or tornado, or a human disaster such as a riot caused by terrorists (hereinafter also referred to as an anomalous event) occurs and handling of the situation is delayed, the resulting damage will be enormous. To minimize the damage, it is necessary to acquire accurate information early from various sources at the location where the anomalous event has occurred. When such event occurs, it is desirable to be able to promptly acquire information such as video pictures from a security system (a fixed camera, for example) installed near the location where the anomalous event has occurred and/or voices from a security guard present around the location; however, such information may not always be acquired and the situation of the site may be understood unsatisfactorily. However, an indefinite number of people are often present at the site, and thus the information can be supplemented by requesting these people to send moving images, still images, sounds, and text information through the portable communication terminals or the like held by the people. In the following first example embodiment, description is given about a technology by which, when an anomalous event occurs in general transport facilities or important infrastructures, people present around the anomalous event are requested to provide moving images, still images, sounds, and text information through portable communication terminals or the like.

Note that wireless communication is mainly used for the provision, and the wireless communication may be wireless local area network (LAN) communication or mobile communication. The wireless LAN communication is, for example, Wi-Fi (registered trademark) communication. The mobile communication is, for example, 4G communication.

(Surveillance System)

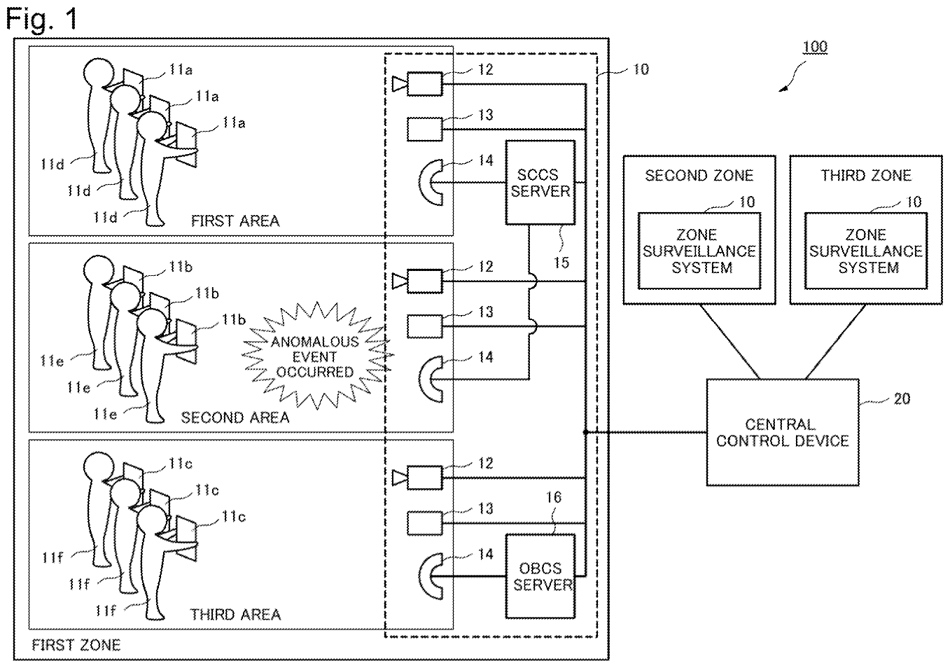

As illustrated in FIG. 1, a surveillance system 100 includes zone surveillance systems 10 disposed in a first zone, a second zone, and a third zone, and a central control device 20 that monitors these zones. Note that the number of zones is not limited to the above-mentioned number.

A zone herein refers to each of airports, railway stations, bus terminals, and the like in the case of general transport facilities such as airports, railway stations, and bus terminals, or to each of markets, stadiums, and the like in the case of important infrastructures such as markets and stadiums. Description is given below on the assumption that the first zone is one railway station and the wireless communication is wireless LAN communication.

A railway station, which is the first zone, is divided for surveillance into a plurality of areas such as, for example, a first area, a second area, and a third area. Note that the number of areas is not limited to the above-mentioned number. It is assumed that the first area and the second area represent different areas in the station yard, and the third area represents an area in a train car. Each of the first to third areas includes a surveillance camera 12, a wireless communication access point 13, and an intercom apparatus 14. The surveillance camera 12 is intended to take surveillance images of the covered area, and is fixed to a ceiling, a wall, or the like. An imaging camera unit (not illustrated) in the surveillance camera 12 may be rotatable, turnable, and angle-adjustable. The wireless communication access point 13, which is, for example, an access point for Wi-Fi (registered trademark) communication, communicably connects portable communication terminals 11a to 11c of customers to the wireless LAN. The intercom apparatus 14 is an extension communication device used in the zone surveillance system 10 disposed in each area, and examples thereof include an extension phone, an emergency phone, a speaker for yard broadcasting or train broadcasting, an electric bulletin board, a signage display, and the like. The intercom apparatuses 14 in the station yard are connected to a station communication control system (SCCS) server 15. The intercom apparatus 14 in the train car is connected to an on-board communication control system (OBCS) server 16.

It is assumed that there is a plurality of customers 11d in the first area (station yard) each possessing a portable communication terminal 11a, there is a plurality of customers 11e in the second area (station yard) each possessing a portable communication terminal 11b, and there is a plurality of customers 11f in the third area (train car) each possessing a portable communication terminal 11c.

It is assumed that each of the portable communication terminals 11a to 11c possessed by the customers has a video camera function capable of taking images. Details will be provided later.

Each of the surveillance cameras 12 in the first to third areas transmits video pictures and the like of the covered area to the central control device 20. Suppose here that an anomalous event has occurred in the second area (see FIG. 1). Then, the central control device 20 analyzes the video pictures transmitted by the surveillance camera 12 in the second area to detect the occurrence of an anomalous event.

Alternatively, an operator on the central control device 20 side may check the video pictures transmitted by the surveillance camera 12 to find an anomalous event. Alternatively, a station attendant or a customer 11e in the second area may use the intercom apparatus (an emergency phone in the station yard, for example) 14 to inform the operator or the like on the central control device 20 side of the anomalous event. A station attendant or a customer 11e in the second area may also use the terminal for station attendants (not illustrated) or the portable communication terminal 11b possessed by the customer to transmit the information regarding the anomalous event (mail, still images, moving images, and the like) to the central control device 20 via the wireless communication access point 13.

When informed of the occurrence of the anomalous event, the central control device 20 attempts to collect detailed information about the anomalous event using the surveillance camera 12 and communications with station attendants through the intercom apparatus 14. This attempt may be made by a program, or may be made by an operator on the basis of the information presented on a display unit 27 of the central control device 20. However, if the information is still insufficient, the central control device 20 transmits an information provision demand to the portable communication terminals 11b possessed by customers for asking the customers to provide information about the anomalous event. After receiving the information provision demand, the portable communication terminals 11b each take images of the anomalous event, functioning as a relay for transmitting video pictures, images, sounds, and the like related to the anomalous event to the central control device 20 in real time. It is assumed that, for this purpose, each of the customers 11e has already downloaded a dedicated application from the central control device 20 and installed the application in the portable communication terminal 11b. In addition, it is assumed that the surveillance system 100 has already obtained the consent of the customer 11e to transmit video pictures and the like from the portable communication terminal 11b of the customer 11e to the central control device 20 when an anomalous event occurs.

On the basis of the video pictures and the like transmitted by the portable communication terminals 11b, the central control device 20 analyzes detailed information about the anomalous event and takes countermeasures against the anomalous event. For example, if the anomalous event is a fire, the central control device 20 notifies a fire station of the fire and activates the fire extinguishing system. If the anomalous event is the occurrence of a terrorist activity, the central control device 20 notifies the police of the occurrence.

Immediately after that, the anomalous event is announced to the customers 11d and 11f in the first area and the third area through yard broadcasting, train broadcasting, and bulletin board presentation by using the intercom apparatuses 14 (speakers, electric bulletin boards, and the like) to encourage the customers to detour around or evacuate from the location where the anomalous event has occurred.

The customers 11e in the second area where the anomalous event has occurred are also encouraged to detour or evacuate through yard broadcasting, training broadcasting, and bulletin board presentation by using the intercom apparatus 14. However, in the second area where the anomalous event has occurred, yard broadcasting and the like may adversely affect the customers 11e, who may face a risk. For example, a riot caused by terrorists in the second area is applicable. In such cases, the central control device 20 may transmit, together with the information provision demand, emergency information that aids in avoiding the anomalous event (for example, the information acquired about the latest state of the anomalous event, actions to be taken by the customers 11e, evacuation routes for the customers 11e, and preparedness of security service or police) to the portable communication terminals 11b of the customers 11e who provided the above-mentioned consent. In addition, to the portable communication terminals 11b of the customers 11e who have not provided the consent, the information provision request may be transmitted, requesting permission to transmit an information provision demand and permission to provide emergency information.

Furthermore, there may be a customer 11f who is currently in a train car (the third area) but has seen the above-mentioned riot or has taken a still image or moving image of the riot from the inside of the train car. Such customer 11f may also be requested to send information regarding the anomalous event (for example, text mail, still images, moving images, and the like) from the portable communication terminal 11c possessed by the customer 11f to the central control device 20.

As described above, not only the surveillance cameras 12 and the intercom apparatuses 14 in the station yard but also the customers 11d to 11f are caused to provide information regarding an anomalous event, whereby the surveillance system 100 quickly collects and analyzes the information regarding the anomalous event and develops countermeasures to evacuate the customers 11d to 11f safely.

(Central Control Device)

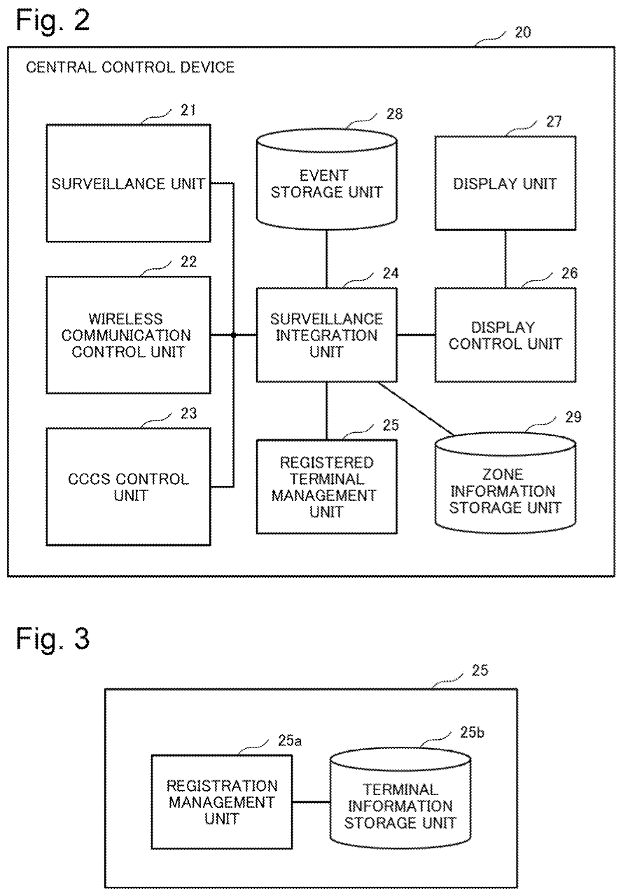

Now, the central control device 20 in the surveillance system 100 is described below with reference to FIG. 2. The central control device 20 includes a surveillance unit 21, a wireless communication control unit 22, a CCCS control unit 23, a surveillance integration unit 24, a registered terminal management unit 25, a display control unit 26, a display unit 27, an event storage unit 28, and a zone information storage unit 29.

The surveillance unit 21 conducts an analysis to determine whether the event appearing in a video picture is anomalous or normal and, if the analysis has led to the determination that the event is anomalous, the surveillance unit 21 outputs the taken video picture to the surveillance integration unit 24. For example, the surveillance unit 21 acquires video pictures taken by the surveillance cameras 12 in the zone surveillance system 10 disposed in each of the first to third zones through wired communication or wireless communication. The surveillance unit 21 monitors the acquired video pictures to find whether there is any anomalous event and, when an anomalous event is detected, the surveillance camera 12 outputs the detection result, information for determining the position of the surveillance camera 12, and the video picture of the anomalous event taken by the surveillance camera 12 to the surveillance integration unit 24. The information for determining the position of the surveillance camera 12 may be an identifier for identifying the surveillance camera 12. The surveillance camera 12 may include a microphone, a temperature sensor, and a humidity sensor (none of them is illustrated). The surveillance unit 21 may analyze video pictures including information such as an environmental sound, a person's voice, a temperature, a humidity, and the like based on outputs from the surveillance camera 12, the microphone, and individual sensors. When an anomaly is detected as a result of the analysis, the surveillance unit 21 may output information such as an environmental sound, a person's voice, a temperature, and a humidity to the central control device 20 together with the video picture of the anomalous event.

Note that a video picture of an anomalous event taken by the surveillance camera 12 for imaging anomalous events and information for determining the position of the surveillance camera 12 (the information regarding the occurrence of an anomalous event and the position of occurrence thereof), as output by the surveillance unit 21, are also referred to as first information. The first information is not limited to video information but may include a sound and the like.

A method for determining whether an event is anomalous is implemented by installing an engine in which images of possible anomalous events are machine-learned in advance or by communicably connecting to the engine, and acquiring a result of determination on an anomalous event from the engine. As a method of machine learning, for example, the technology described in PTL 3 may be used. A plurality of surveillance camera video pictures, sounds, and the like may be used for an anomalous event. As a technical surveillance method employing camera video pictures and sounds from a plurality of angles, for example, the technologies described in PTL 4 and PTL 5 can be used.

The wireless communication control unit 22 acquires the status and the like of the wireless LAN in use from the wireless communication access points 13 in the zone surveillance system 10 in the first to third zones through wired communication or wireless communication and controls the overall wireless communication.

The CCCS control unit 23 manages and controls the SCCS server 15 and the OBCS server 16. The SCCS server 15 is connected to the intercom apparatuses 14 in the first and second areas in the station yard in a wired or wireless manner to control these apparatuses. The OBCS server 16 is connected to the intercom apparatuses 14 in train cars in the second area in a wired or wireless manner to control these apparatuses.

As illustrated in FIG. 3, the registered terminal management unit 25 includes a registration management unit 25a and a terminal information storage unit 25b. The terminal information storage unit 25b stores information for uniquely identifying the portable communication terminals 11a and 11b that have replied that they accept the information provision request as a result of transmission of the information provision request requesting permission to transmit an information provision demand. The information for identifying the portable communication terminals is, for example, an Internet Protocol (IP) address associated with each of the portable communication terminals. The registration management unit 25a performs processes including new registration, updating, and deletion of the information for identifying the portable communication terminals. In addition, when the surveillance integration unit 24 is requested to submit information for identifying a registered portable communication terminal existing in a certain area, the applicable information for identifying the portable communication terminal is retrieved from the terminal information storage unit 25b and delivered to the surveillance integration unit 24.

The display unit 27 is a display for displaying, for example, a result of processing in the central control device 20.

The display control unit 26 displays a result of processing in the central control device 20 on the display unit 27 and receives a reply, instruction, and the like obtained in response to the information displayed via a touch panel or the like on the display unit 27. The above-mentioned reply and the like may be received via a keyboard or physical button (not illustrated) connected to the central control device 20.

The event storage unit 28 stores information about an anomalous event, the information being transmitted from the surveillance cameras 12, the intercom apparatuses 14, the portable communication terminals 11a to 11c, and the like.

The zone information storage unit 29 stores information about the first to third zones. The information includes, for example, information about the number of the surveillance cameras 12, the number of the wireless communication access points 13, the number of the intercom apparatuses 14 in each area included in each zone, types of the apparatuses, and positions of the fixed apparatuses, and further includes information about a map of each zone and evacuation routes in each zone.

(Surveillance Integration Unit)

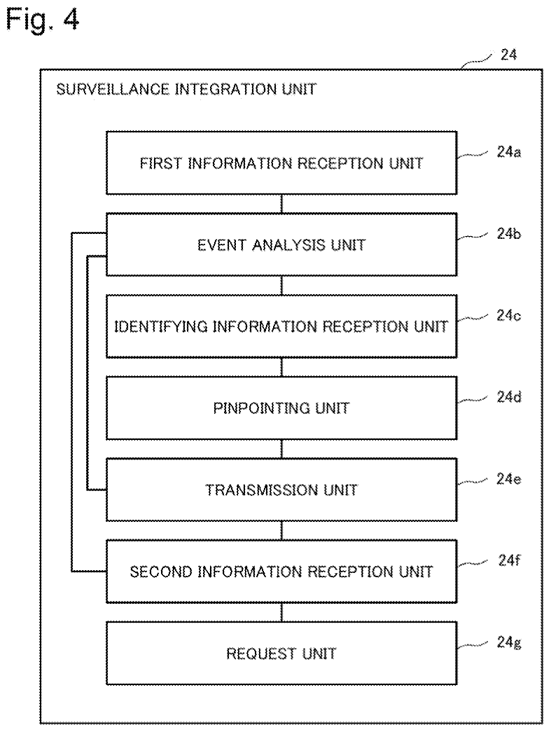

Referring to FIG. 4, the following describes the surveillance integration unit 24 in detail. The surveillance integration unit 24 includes a first information reception unit 24a, an event analysis unit 24b, an identifying information reception unit 24c, a pinpointing unit 24d, a transmission unit 24e, a second information reception unit 24f, and a request unit 24g.

The first information reception unit 24a receives first information from the surveillance unit 21, the first information pertaining to the occurrence of an anomalous event and the position of occurrence thereof. The first information is not limited to video information but may include information such as sounds. In addition, an operator may generate the first information on the basis of a report about the occurrence of an anomalous event provided by a station attendant or the like through the intercom apparatus 14 and the CCCS control unit 23, or of text information and/or photographs appearing in mail or the like. The first information received by the first information reception unit 24a may be stored in the event storage unit 28.

The event analysis unit 24b analyzes the first information to identify details of the event, the position of occurrence of the event, and the like. For example, the event analysis unit 24b identifies the type of the anomalous event imaged by the surveillance camera 12 (for example, a fire, a riot, or the like). A method for identifying an anomalous event on the basis of images is implemented by installing an engine in which images of possible anomalous events are machine-learned in advance or by communicably connecting to the engine, and acquiring a result of determination on an anomalous event from the engine. As a method of machine learning, for example, the technology described in PTL 3 may be used. The event analysis unit 24b identifies the position of occurrence of the event from the position of the fixed surveillance camera 12 and the captured video pictures, on the basis of the information for identifying the position of the surveillance camera 12 and the information stored in the zone information storage unit 29. The event analysis unit 24b causes, through the display control unit 26, the display unit 27 to display the result of the analysis so that an operator or the like on the central control device 20 side checks details of the anomalous event and details of the position of occurrence of the anomalous event. On the basis of details of the anomalous event and the position of occurrence of the anomalous event, the operator determines whether to transmit an information provision demand to the portable communication terminals 11a to 11c of the customers 11d to 11f. As a result of the determination, when an instruction from the operator that an information provision demand is to be transmitted to the portable communication terminals 11a to 11c is received via the display unit 27 and the display control unit 26, the instruction is transmitted to the identifying information reception unit 24c. Note that the determination about an instruction may be made automatically by a program.

If information about an anomalous event has been received from the portable communication terminals 11a to 11c, the event analysis unit 24b may acquire the latitude and longitude from the IP address of each of the portable communication terminals 11a to 11c to identify the position of occurrence of the event.

Furthermore, on the basis of the position of occurrence of the event, the event analysis unit 24b may create emergency information for evacuating the customers. The event analysis unit 24b creates the emergency information by using the information regarding maps of the zones and evacuation routes stored in the zone information storage unit 29.

The identifying information reception unit 24c receives, through wireless communication, information for identifying one or more portable communication terminals 11b present in a specific area including the received position of occurrence of the anomalous event. For example, upon receiving the instruction for an information provision demand, the identifying information reception unit 24c instructs the wireless communication control unit 22 to acquire and deliver the IP address of any portable communication terminal 11b present in a certain area (in the case of FIG. 1, the second area in the first zone). When the wireless communication control unit 22 delivers IP addresses of the portable communication terminals 11b, as received from the above-mentioned second area in accordance with the instruction, the identifying information reception unit 24c delivers these IP addresses to the pinpointing unit 24d.

The identifying information reception unit 24c may acquire the latitude and longitude from the IP address of each of the portable communication terminals 11a to 11c and receive, through wireless communication, information for identifying the portable communication terminals 11b in a desired location.

The pinpointing unit 24d pinpoints the portable communication terminal (in the case of FIG. 1, the portable communication terminals 11b) to which the information provision demand is to be transmitted, from among the portable communication terminals 11a to 11c that are present in the wireless communication area covering the position of occurrence of the anomalous event and that are associated with the identifying information stored in the terminal information storage unit 25b. For example, the pinpointing unit 24d requests the registered terminal management unit 25 to conduct a search to find whether the IP addresses of the portable communication terminals 11b as received from the second area include the IP address of any portable communication terminal 11b that already gave the consent to the information provision demand.

When the registered terminal management unit 25 receives the request, the registration management unit 25a retrieves the IP address that is stored in the terminal information storage unit 25b and matches the IP address of the portable communication terminal 11b as received from the second area. The retrieved IP address is delivered to the pinpointing unit 24d in the surveillance integration unit 24.

If no portable communication terminal that is present in a wireless communication area covering the position of occurrence of the anomalous event and is associated with the identifying information stored in the terminal information storage unit 25b is found, the pinpointing unit 24d may transmit an information provision request to portable communication terminals (the portable communication terminals 11b in the case of FIG. 1) present in one or more of the above-described wireless communication areas covering the position of occurrence.

Upon receiving the retrieved IP address, the transmission unit 24e transmits the information provision demand to the portable communication terminal 11b associated with the IP address. Note that the event analysis unit 24b may differentiate the information to be given to the customers 11d to 11f depending on the importance of details of the event. For example, the event analysis unit 24b may instruct the transmission unit 24e to transmit, to the portable communication terminals 11a to 11c of the customers, the information provision demand in the case of failure of equipment or the like in the station yard, or both the information provision demand and emergency information in the case of a riot caused by terrorists, a big fire, or the like. The transmission unit 24e transmits the information provision demand to the portable communication terminal 11b associated with the retrieved IP address through the wireless communication control unit 22 and the wireless communication access point 13.

The second information reception unit 24f receives, from the portable communication terminal 11b associated with the above-mentioned IP address that has been retrieved, information (second information) regarding the occurrence of the anomalous event and the position of occurrence thereof in response to the information provision demand.

The second information includes video pictures, sounds, still images, text information, and the like received from the portable communication terminal 11b. If the second information is in the form of video pictures or sounds, the transmission unit 24e may transmit the information provision demand including a message requesting, through the portable communication terminal 11b, the customer 11e to relay the second information in real time. The information provision demand may further include the desired target and location to be covered (including a request that the customer 11e is to move to a different place). The second information reception unit 24f may further receive video pictures and sounds that are already recorded, photographs that are already taken, and text information (mail, for example) that describes the anomalous event in detail from the portable communication terminal 11b. The second information received by the second information reception unit 24f may be stored in the event storage unit 28. Details of the second information received by the second information reception unit 24f may be analyzed by the event analysis unit 24b.

The request unit 24g creates an information provision request requesting permission to transmit the information provision demand, and instructs the transmission unit 24e to send the information provision request to the portable communication terminals 11a to 11c. In addition, the request unit 24g creates the information provision demand and information (for example, a linked uniform resource locator (URL)) prompting the portable communication terminals 11a to 11c that have replied that the information provision request is accepted to connect to the wireless communication controlled by the wireless communication access point 13, and instructs the transmission unit 24e to transmit such information. In accordance with the instruction given by the request unit 24g, the transmission unit 24e transmits, to the portable communication terminals 11a to 11c, the information provision request, the information provision demand, and the information prompting the terminals to connect to the wireless communication.

An example of the information provision request is the following text shown on a screen: “You are now in an area where Wi-Fi connection is provided for free. As you are connected for free, you are asked for cooperation in providing information in the event that an emergency occurs. Do you consent to the cooperation? To provide information, a dedicated application needs to be downloaded. If you want to give the consent, press the consent button (the consent button is attached).”

An example of the information prompting a terminal to connect to the wireless communication is the following text and URL shown on a screen: “Thank you for your cooperation in providing information in the event an emergency occurs. The download URL for the dedicated application is here (the linked URL is attached). The URL for Wi-Fi free connection is here (the linked URL is attached).”

An example of the information provision demand is the following text shown on a screen: “XXX is occurring around you. You are asked for cooperation in providing information. As your portable communication terminal will be connected to the central control management room in ten seconds, please take an image of XXX.” When the information provision demand is transmitted, a screen for confirming that the customer 11e is currently prepared for providing information may additionally be sent to obtain a reply that the customer can provide information before the customer starts taking an image to relay information.

An example of the emergency information is the following text and URL shown on a screen: “XXX is occurring around you. You are asked for cooperation in providing information. Evacuation routes from XXX and other information for ensuring your safety can be obtained here (a linked URL is attached).”

Each of the screens above is shown on the displays (not illustrated) of the portable communication terminals 11a to 11c. Information including figures and photographs may be displayed on any of the screens.

In normal times (when no anomalous event is occurring), the request unit 24g may instruct the transmission unit 24e to transmit an information provision request to the portable communication terminals 11a to 11c that have been found entering the wireless communication area covered by each wireless communication access point 13 (for example, an area covered by a Wi-Fi (registered trademark) access point).

In addition, when an anomalous event has occurred, the request unit 24g may instruct the transmission unit 24e to transmit an information provision request to the portable communication terminals (portable communication terminals 11b in the case of FIG. 1) that are present in the wireless communication area covering the position of occurrence. This is effective when, for example, the portable communication terminals 11a to 11c that will provide the second information are absent in the wireless communication area where the anomalous event has been found.

(Portable Communication Terminal)

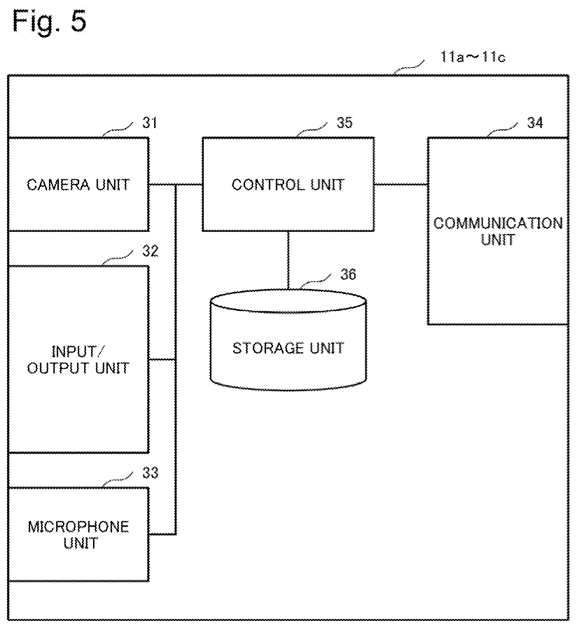

Referring to FIG. 5, the following describes a configuration of the portable communication terminals 11a to 11c. The portable communication terminals 11a to 11c each include a camera unit 31, an input/output unit 32, a microphone unit 33, a communication unit 34, a control unit 35, and a storage unit 36.

The camera unit 31 is a camera that takes moving images and/or still images. The input/output unit 32, which is, for example, a touch panel display, displays predetermined information and receives a reply to the displayed information. The microphone unit 33 is a microphone for collecting sounds. The communication unit 34 communicates with the outside through wired communication or wireless communication.

The control unit 35 controls these apparatuses 31 to 34. The control unit 35 presents, to the input/output unit 32, an information provision request, an information provision demand, and the like that are received from the central control device 20 via the communication unit 34, and receives and transmits replies from the customers 11d to 11f. The control unit 35 receives text information from the input/output unit 32 and transmits the text information to the central control device 20 via the communication unit 34. The control unit 35 receives the dedicated application for relaying information from the central control device 20 via the communication unit 34, and stores the application in the storage unit 36. Furthermore, the control unit 35 manages installation, activation, and the like of the dedicated application.

(Operations of Surveillance System)

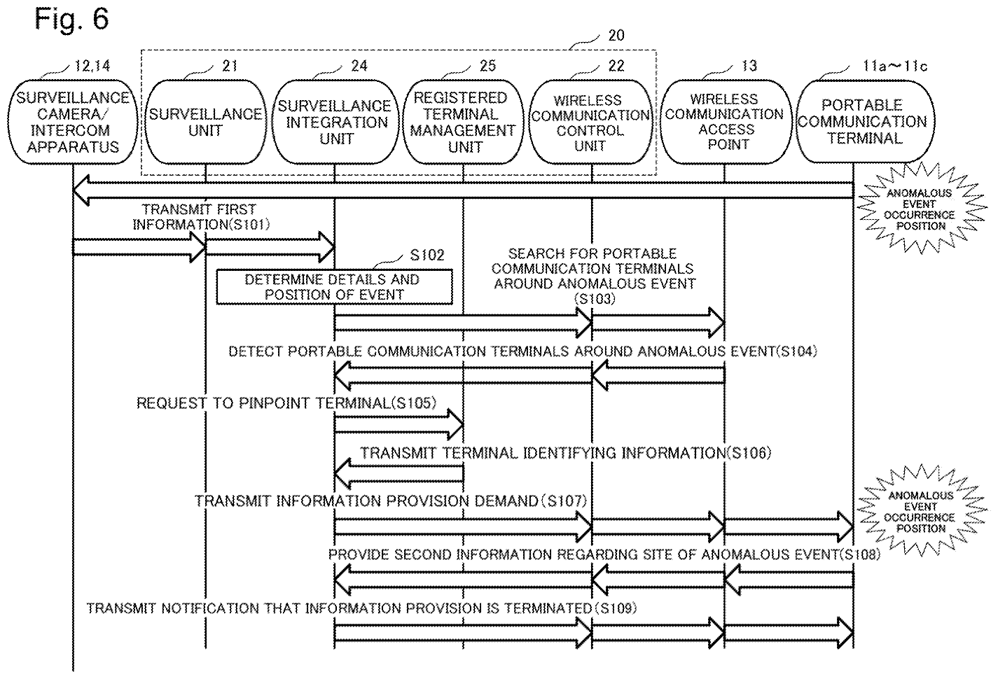

Operations of the surveillance system 100 according to the first example embodiment will now be described with reference to the sequence diagram in FIG. 6. It is assumed that, in previous normal times, the transmission unit 24e transmitted an information provision request to the portable communication terminals 11a to 11c that were found entering the wireless communication area in the station yard or in a train car and the replies of consent were obtained, and the registered terminal management unit 25 manages the registered terminals, that is, the information for identifying the portable communication terminals 11a to 11c that gave the consent. It is further assumed that the dedicated application has already been downloaded to each of the portable communication terminals 11a to 11c.

First, in step S101, the surveillance camera 12 takes video pictures of the surveillance area. The surveillance camera 12 transmits the taken video pictures to the surveillance unit 21 in the central control device 20.

In step S102, the surveillance unit 21 conducts an analysis to determine whether the event appearing in the video pictures is anomalous or normal and, if the analysis has led to the determination that the event is anomalous, the surveillance unit 21 outputs, as first information, the taken video picture to the surveillance integration unit 24. The event analysis unit 24b in the surveillance integration unit 24 determines details of the event and the position of occurrence of the event on the basis of the first information. Alternatively, a station attendant or a passenger who has found the anomalous event may notify the surveillance integration unit 24 of the occurrence of an anomalous event through the intercom apparatus 14 (an emergency phone or the like).

In step S103, the identifying information reception unit 24c in the surveillance integration unit 24 requests the wireless communication control unit 22 to search for information for identifying one or more portable communication terminals (the portable communication terminals 11b in the case of FIG. 1) being present in a specific area including the position of occurrence. The wireless communication control unit 22 acquires the search for the identifying information from the wireless communication access point 13.

In step S104, the wireless communication control unit 22 transmits the information for identifying the portable communication terminals 11b to the identifying information reception unit 24c in the surveillance integration unit 24.

In step S105, the pinpointing unit 24d in the surveillance integration unit 24 pinpoints, on the basis of the position of occurrence of the anomalous event and the identifying information, the portable communication terminal 11b to which an information provision demand regarding the position of occurrence is to be transmitted. For example, the pinpointing unit 24d requests the registered terminal management unit 25 to pinpoint the portable communication terminal 11b to which the information provision demand is to be transmitted, from among the portable communication terminals that are present in at least one wireless communication area covering the position of occurrence of the anomalous event and that are associated with the identifying information stored in the terminal information storage unit 25b. The registered terminal management unit 25 retrieves information for identifying the portable communication terminal 11b to which the information provision demand is to be transmitted.

In step S106, the registered terminal management unit 25 delivers the identifying information to the surveillance integration unit 24. The pinpointing unit 24d in the surveillance integration unit 24 receives, from the registered terminal management unit 25, the information for identifying the portable communication terminal 11b to which the information provision demand is to be transmitted.

In step S107, the transmission unit 24e in the surveillance integration unit 24 transmits the information provision demand to the portable communication terminal 11b to which the information provision demand should be transmitted. The information provision demand is transmitted from the surveillance integration unit 24 through the wireless communication control unit 22 and the wireless communication access point 13 to the portable communication terminal 11b to which the information provision demand should be transmitted. At the same time, it may be desirable to transmit the emergency information together with the information provision demand depending on specifics of the anomalous event.

In step S108, the portable communication terminal 11b that has received the information provision demand starts the dedicated application and, serving as a relay, transmits second information regarding the occurrence of the anomalous event and the position of occurrence thereof to the central control device 20. The second information is transmitted from the portable communication terminal 11b through the wireless communication access point 13 and the wireless communication control unit 22 to the surveillance integration unit 24.

In step S109, when the second information has been acquired to a sufficient extent, the surveillance integration unit 24 notifies the portable communication terminal 11b through the transmission unit 24e that the information provision demand is terminated.

Operations of the surveillance system 100 are now finished.

### First Modification of First Example Embodiment

The display control unit 26 in the central control device 20 displays the second information on the display unit 27, the second information being received by the second information reception unit 24f in the surveillance integration unit 24. When a request has been received from an operator or the like to perform an operation on one or more pieces of the second information (for example, a plurality of captured images transmitted from a plurality of portable communication terminals) to be displayed, such as adjusting the imaging position, the imaging angle, or the like, the display control unit 26 may give, to the portable communication terminal 11b that has transmitted the second information, a notification of a request to perform an operation on the imaging of the second information. The request to perform operations may be, for example, “Move to the right about 1 m and take an image.” or “Take an image of the ceiling.” The request to perform operations is transmitted from the transmission unit 24e to the portable communication terminal 11b that has transmitted the second information.

### Second Modification of First Example Embodiment

The permission to connect from the portable communication terminals 11a to 11c to the wireless communication access points 13 for free of charge may be given at a timing when a reply to the effect that the information provision demand is accepted is received from a portable communication terminal, the registration management unit 25a in the registered terminal management unit 25 acquires information for identifying the portable communication terminal (an IP address, for example), and the information is registered (stored) in the terminal information storage unit 25b (see FIG. 3). Alternatively, the permission may be given at a time when the dedicated application has been downloaded to the portable communication terminals 11a to 11c. Alternatively, the permission may be given after the notification that registration has been completed is given by the registered terminal management unit 25, or after the notification that installation of the application has been completed is given by the portable communication terminals 11a to 11c and the notification that registration has been completed is given by the registered terminal management unit 25.

### Third Modification of First Example Embodiment

A certain incentive may be given to the portable communication terminals 11a to 11c that have provided the second information. For example, when the transmission unit 24e transmits at least either one of the information provision request and the information provision demand to the portable communication terminals 11a to 11c, a motivation to provide information may be given by transmitting, together with the request or demand, the information to the effect that an incentive will be given to the portable communication terminal that transmits the second information. The incentive is, for example, providing rewards, providing free calls and/or free packet communications for a predetermined period of time, discounts on communication charges, and the like.

The incentive may be determined in accordance with the length of time that the portable communication terminals 11a to 11c transmit (relay) the second information. The incentive may also be determined in accordance with the distance from the position of occurrence of an anomalous event to the customer 11e holding the portable communication terminal 11b. Alternatively, the incentive may be determined in accordance with the contents of the second information. For example, a high reward may be given to the portable communication terminal 11b which has transmitted an image of the criminal of the incident as the second information.

A certain incentive may also be given to the portable communication terminals 11a to 11c that have provided the first information.

### Effects of First Example Embodiment

According to the first example embodiment, an instruction can be sent to the portable communication terminals or the like held by people present around the location where an anomalous event has occurred to collect information regarding the event. This is because, as of the time when the anomalous event occurs, the central control device 20 in the surveillance system 100 has already obtained the consent to cooperate in providing information, and the central control device 20 pinpoints the portable communication terminal 11b to which an information provision demand regarding the position of occurrence of the anomalous event should be transmitted, the portable communication terminal 11b being present around the position of occurrence, and then transmits the information provision demand regarding the position of occurrence to the pinpointed portable communication terminal 11b.

Furthermore, according to the first example embodiment, the safety of the customers 11d to 11f can be assured. This is because the central control device 20 transmits, together with the information provision demand, emergency information that aids in avoiding the anomalous event to the portable communication terminals 11b of the customers 11e present in an area where the anomalous event has occurred.

As described above, not only the surveillance cameras 12 and the intercom apparatuses 14 in the station yard but also the customers 11d to 11f are caused to provide information regarding an anomalous event, whereby the central control device 20 of the present example embodiment quickly collects and analyzes the information regarding the anomalous event and develops countermeasures. As a result, the surveillance system 100 as a whole is capable of evacuating the customers 11d to 11f safely.

### Second Example Embodiment

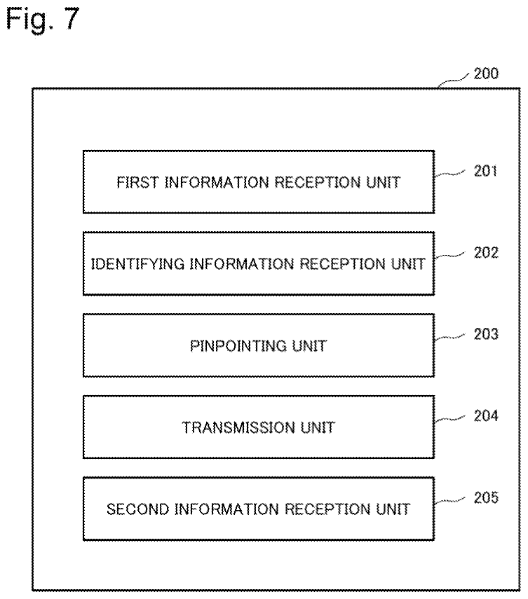

As illustrated in FIG. 7, a surveillance control device (central control device) 200 according to a second example embodiment includes a first information reception unit 201, an identifying information reception unit 202, a pinpointing unit 203, a transmission unit 204, and a second information reception unit 205.

The first information reception unit 201 receives first information regarding the occurrence of an anomalous event and the position of occurrence thereof.

The identifying information reception unit 202 receives, through wireless communication, information for identifying one or more portable communication terminals present in a specific area including the position of occurrence.

On the basis of the position of occurrence and the identifying information, the pinpointing unit 203 pinpoints, from among portable communication terminals, the portable communication terminal to which an information provision demand regarding the position of occurrence is to be transmitted.

The transmission unit 204 transmits the information provision demand to the portable communication terminal.

The second information reception unit 205 receives, from the portable communication terminal, second information regarding the occurrence of the anomalous event and the position of occurrence thereof, the second information being related to the information provision demand.

As described above, according to the second example embodiment, an instruction can be sent to the portable communication terminals or the like held by people present around the location where an anomalous event has occurred to collect information regarding the event. This is because, as of the time when the anomalous event occurs, the surveillance control device 20 has already obtained the consent to cooperate in providing information, and the surveillance control device 20 pinpoints the portable communication terminal to which an information provision demand regarding the position of occurrence of the anomalous event should be transmitted, the portable communication terminal being present around the position of occurrence, and then transmits the information provision demand regarding the position of occurrence to the pinpointed portable communication terminal 11b.

(Information Processing Device)

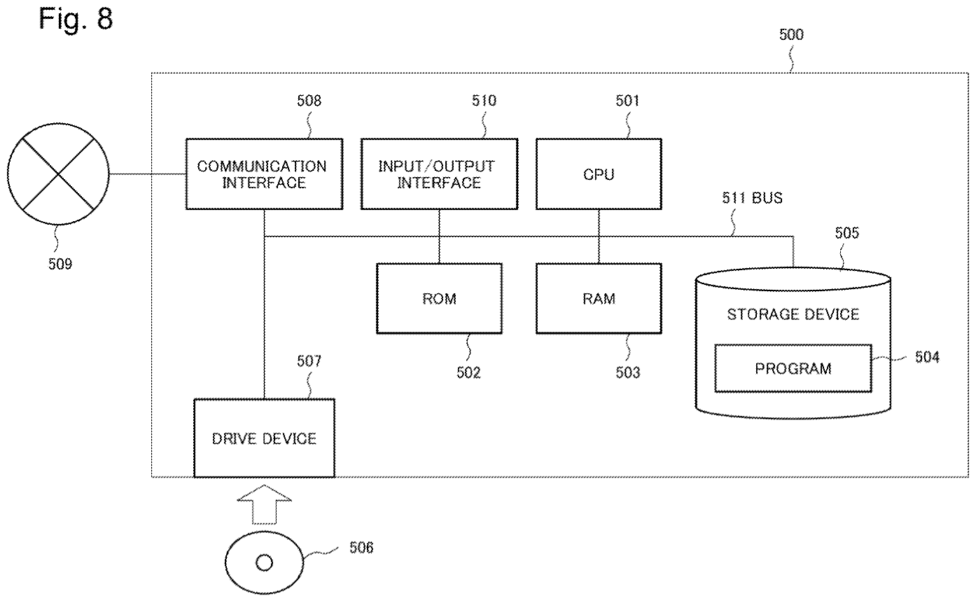

In each of the above-described example embodiments of the present invention, part or all of each component of the central control device (surveillance control device) illustrated in FIGS. 2, 4, 7, and others and the configuration of the portable communication terminals 11a to 11c illustrated in FIG. 5 can be implemented by using any combination of, for example, an information processing device 500 illustrated in FIG. 8 and programs. The information processing device 500 includes, for example, the following components.
Central processing unit (CPU) 501
Read only memory (ROM) 502
Random access memory (RAM) 503
Storage device 505 storing a program 504 and other data
Drive device 507 for reading from and writing to a recording medium 506
Communication interface 508 connected to a communication network 509
Input/output interface 510 for inputting/outputting data
Bus 511 connecting the components

The components of the central control device in each of the example embodiments of the present application are implemented by the CPU 501 acquiring and executing the program 504 that implements functions of these components. The program 504 implementing functions of the components of the central control device is stored in advance in, for example, the storage device 505 or the RAM 503 and is read out by the CPU 501 as necessary. The program 504 may be supplied to the CPU 501 via the communication network 509, or may be stored in the recording medium 506 in advance and read and supplied to the CPU 501 by the drive device 507. The drive device 507 may be an external device attachable to each apparatus.

A method for implementing each device has various modifications. For example, each of the components of the central control device may be implemented by any combination of a separate information processing device and programs. Alternatively, the plurality of components included in the central control device may be implemented by any combination of a single information processing device 500 and programs.

Furthermore, part or all of each component of the central control device is implemented by other general-purpose or dedicated circuits, processors, or the like, or by a combination thereof. These devices may be included in a single chip or may be included in a plurality of chips connected via a bus.

Part or all of each component of the central control device may be implemented by a combination of the above-mentioned circuits and others with programs.

In the case where part or all of each component of the central control device is implemented by a plurality of information processing devices, circuits, and the like, the plurality of information processing devices, circuits, and the like may be disposed in a centralized or distributed manner. For example, the information processing devices, the circuits, and the like may be implemented in the form in which each of the devices, circuits, and the like is connected via a communication network, such as a client and server system, a cloud computing system, and the like.

The whole or part of the example embodiments disclosed above can be described as, but not limited to, the following supplementary notes.

### [Supplementary Note 1]

A surveillance control device comprising:

first information reception means for receiving first information regarding occurrence of an anomalous event and a position of occurrence of the anomalous event;

identifying information reception means for receiving, through wireless communication, information for identifying one or more portable communication terminals being present in a specific area including the position of occurrence;

pinpointing means for pinpointing, from among the portable communication terminals and based on the position of occurrence and the information for identifying, a portable communication terminal to which an information provision demand regarding the position of occurrence is to be transmitted;

transmission means for transmitting the information provision demand to the portable communication terminal; and

second information reception means for receiving, from the portable communication terminal, second information regarding the occurrence of the anomalous event and the position of occurrence of the anomalous event, the second information being related to the information provision demand.

### [Supplementary Note 2]

The surveillance control device according to Supplementary Note 1, wherein

the transmission means transmits, to the portable communication terminals, an information provision request requesting permission to transmit the information provision demand, and transmits, to the portable communication terminal that has given a reply to an effect that the information provision request is accepted, the information provision demand and information prompting the portable communication terminal to connect to the wireless communication.

### [Supplementary Note 3]

The surveillance control device according to Supplementary Note 2, further comprising:

wireless communication control means for controlling wireless communication in each of at least one wireless communication area, wherein

when the wireless communication control means determines that the portable communication terminal has entered the wireless communication area, the transmission means transmits the information provision request to the portable communication terminal.

### [Supplementary Note 4]

The surveillance control device according to Supplementary Note 2, wherein

when the anomalous event occurs, the transmission means transmits the information provision request to a portable communication terminal being present in the at least one wireless communication area covering the position of occurrence.

### [Supplementary Note 5]

The surveillance control device according to Supplementary Note 1, further comprising:

surveillance means for conducting an analysis to determine whether an event included in received information including the first information is anomalous or normal and, if the analysis has led to a determination that the event is anomalous, outputting the first information to the first information reception means.

### [Supplementary Note 6]

The surveillance control device according to Supplementary Note 1, wherein

the pinpointing means pinpoints, from among portable communication terminals being present in at least one wireless communication area covering the position of occurrence, a terminal to which the information provision demand is to be transmitted.

### [Supplementary Note 7]

The surveillance control device according to Supplementary Note 6, further comprising:

terminal storage means for storing information for identifying the portable communication terminal that permits the information provision demand to be transmitted, wherein

the pinpointing means pinpoints, from among the portable communication terminals being present in the at least one wireless communication area covering the position of occurrence and being associated with the information for identifying stored in the terminal storage means, the portable communication terminal to which the information provision demand is to be transmitted.

### [Supplementary Note 8]

The surveillance control device according to Supplementary Note 6, further comprising:

terminal information storage means for storing information for identifying the portable communication terminal that permits the information provision demand to be transmitted, wherein

when there is no portable communication terminal that is present in the at least one wireless communication area covering the position of occurrence and is associated with the information for identifying stored in the terminal storage means, the pinpointing means transmits an information provision request requesting permission to transmit the information provision demand to a portable communication terminal being present in the at least one wireless communication area covering the position of occurrence.

### [Supplementary Note 9]

The surveillance control device according to any one of Supplementary Notes 1 to 4, further comprising:

display control means for displaying the second information on display means, the second information being received by the second information reception means, wherein

when the display control means receives a request to perform an operation on one or more pieces of the second information to be displayed, the transmission means transmits the request to perform an operation to the portable communication terminal that has transmitted the second information.

### [Supplementary Note 10]

The surveillance control device according to any one of Supplementary Notes 1 to 4, wherein

the transmission means transmits the information provision demand and emergency information that aids in avoiding the anomalous event to the portable communication terminal.

### [Supplementary Note 11]

The surveillance control device according to any one of Supplementary Notes 2 to 4, wherein

when transmitting at least either one of the information provision request and the information provision demand to the portable communication terminal, the transmission means transmits, to the portable communication terminal, information to an effect that an incentive is given by transmitting the second information.

### [Supplementary Note 12]

The surveillance control device according to Supplementary Note 11, wherein

the incentive is determined in accordance with a length of time that the second information is transmitted.

### [Supplementary Note 13]

The surveillance control device according to Supplementary Note 11, wherein

the incentive is determined in accordance with a distance from the position of occurrence to the portable communication terminal.

### [Supplementary Note 14]

The surveillance control device according to Supplementary Note 11, wherein

the incentive is determined in accordance with contents of the second information.

### [Supplementary Note 15]

The surveillance control device according to Supplementary Note 3, further comprising:

registered terminal management means for, when a reply to an effect that the information provision demand is accepted is received from a portable communication terminal, acquiring information for identifying the portable communication terminal and storing the information in terminal information storage means, wherein

after the reply is received, the wireless communication control means connects the portable communication terminal to the wireless communication in the wireless communication area.

### [Supplementary Note 16]

The surveillance control device according to Supplementary Note 3 or 15, wherein

the wireless communication is wireless LAN communication, and the wireless communication control means controls an access point for the wireless LAN communication.

### [Supplementary Note 17]

The surveillance control device according to Supplementary Note 3 or 15, wherein

the wireless communication is mobile communication, and the wireless communication control means controls a base station for the mobile communication.

### [Supplementary Note 18]

A surveillance system comprising:

the surveillance control device according to any one of Supplementary Notes 1 to 17;

a zone surveillance system that is disposed in each of surveillance zones and is communicably connected to the surveillance control device; and

a portable communication terminal that is held by a customer present in each of the surveillance zones and is capable of taking an image, wherein

the zone surveillance system comprises at least one of:

a surveillance camera;

a wireless communication connection point; and

an intercom apparatus.

### [Supplementary Note 19]

A surveillance method comprising:

receiving first information regarding occurrence of an anomalous event and a position of occurrence of the anomalous event;

receiving, through wireless communication, information for identifying one or more portable communication terminals being present in a specific area including the position of occurrence;

pinpointing, from among the portable communication terminals and based on the position of occurrence and the information for identifying, a portable communication terminal to which an information provision demand regarding the position of occurrence is to be transmitted;

transmitting the information provision demand to the portable communication terminal; and

receiving, from the portable communication terminal, second information regarding the occurrence of the anomalous event and the position of occurrence of the anomalous event, the second information being related to the information provision demand.

### [Supplementary Note 20]

The surveillance method according to Supplementary Note 19, wherein

the transmitting includes transmitting, to the portable communication terminals, an information provision request requesting permission to transmit the information provision demand, and transmitting, to the portable communication terminal that has given a reply to an effect that the information provision request is accepted, the information provision demand and information prompting the portable communication terminal to connect to the wireless communication.

### [Supplementary Note 21]

The surveillance method according to Supplementary Note 20, further comprising:

controlling wireless communication in each of at least one wireless communication area, wherein

the transmitting includes, when it is determined, during controlling of the wireless communication, that the portable communication terminal has entered the wireless communication area, transmitting the information provision request to the portable communication terminal.

### [Supplementary Note 22]

The surveillance method according to Supplementary Note 20, wherein

the transmitting includes, when the anomalous event occurs, transmitting the information provision request to a portable communication terminal being present in the at least one wireless communication area covering the position of occurrence.

### [Supplementary Note 23]

The surveillance method according to Supplementary Note 19, further comprising:

conducting an analysis to determine whether an event included in received information including the first information is anomalous or normal and, if the analysis has led to a determination that the event is anomalous, outputting the first information.

### [Supplementary Note 24]

The surveillance method according to Supplementary Note 19, wherein

the pinpointing includes pinpointing, from among portable communication terminals being present in the at least one wireless communication area covering the position of occurrence, a terminal to which the information provision demand is to be transmitted.

### [Supplementary Note 25]

The surveillance method according to Supplementary Note 24, wherein

the pinpointing includes pinpointing the portable communication terminal to which the information provision demand is to be transmitted, from among the portable communication terminals being present in the at least one wireless communication area covering the position of occurrence and being associated with information for identifying the portable communication terminal that permits the information provision demand to be transmitted, the information for identifying being stored in terminal storage means.

### [Supplementary Note 26]

The surveillance method according to Supplementary Note 24, wherein

the pinpointing includes, when there is no portable communication terminal that is present in the at least one wireless communication area covering the position of occurrence and is associated with information for identifying the portable communication terminal that permits the information provision demand to be transmitted, the information for identifying being stored in terminal storage means, transmitting an information provision request requesting permission to transmit the information provision demand to a portable communication terminal being present in the at least one wireless communication area covering the position of occurrence.

### [Supplementary Note 27]

The surveillance method according to any one of Supplementary Notes 19 to 22, further comprising:

controlling display of the second information on display means, the second information being received from the portable communication terminal, wherein

the controlling display includes, when a request to perform an operation on one or more pieces of the second information to be displayed is received, transmitting the request to perform an operation to the portable communication terminal that has transmitted the second information.

### [Supplementary Note 28]

The surveillance method according to any one of Supplementary Notes 19 to 22, wherein

the transmitting includes transmitting the information provision demand and emergency information that aids in avoiding the anomalous event to the portable communication terminal.

### [Supplementary Note 29]

The surveillance method according to any one of Supplementary Notes 20 to 22, wherein

the transmitting includes, when at least either one of the information provision request and the information provision demand is transmitted to the portable communication terminal, transmitting, to the portable communication terminal, information to an effect that an incentive is given by transmitting the second information.

### [Supplementary Note 30]

The surveillance method according to Supplementary Note 29, wherein

the incentive is determined in accordance with a length of time that the second information is transmitted.

### [Supplementary Note 31]

The surveillance method according to Supplementary Note 29, wherein

the incentive is determined in accordance with a distance from the position of occurrence to the portable communication terminal.

### [Supplementary Note 32]

The surveillance method according to Supplementary Note 29, wherein

the incentive is determined in accordance with contents of the second information.

### [Supplementary Note 33]

The surveillance method according to Supplementary Note 21, further comprising:

when a reply to an effect that the information provision demand is accepted is received from a portable communication terminal, acquiring information for identifying the portable communication terminal and storing the information in terminal information storage means, wherein

the controlling wireless communication includes, after the reply is received, connecting the portable communication terminal to the wireless communication in the wireless communication area.

### [Supplementary Note 34]

The surveillance method according to Supplementary Note 21 or 33, wherein

the wireless communication is wireless LAN communication, and the controlling wireless communication includes controlling an access point for the wireless LAN communication.

### [Supplementary Note 35]

The surveillance method according to Supplementary Note 21 or 33, wherein

the wireless communication is mobile communication, and the controlling wireless communication includes controlling a base station for the mobile communication.

### [Supplementary Note 36]

A recording medium storing a surveillance program that causes a computer to implement:

receiving first information regarding occurrence of an anomalous event and a position of occurrence of the anomalous event;

receiving, through wireless communication, information for identifying one or more portable communication terminals being present in a specific area including the position of occurrence;

pinpointing, from among the portable communication terminals and based on the position of occurrence and the information for identifying, a portable communication terminal to which an information provision demand regarding the position of occurrence is to be transmitted;

transmitting the information provision demand to the portable communication terminal; and

receiving, from the portable communication terminal, second information regarding the occurrence of the anomalous event and the position of occurrence of the anomalous event, the second information being related to the information provision demand.

### [Supplementary Note 37]

The recording medium according to Supplementary Note 36, wherein

the transmitting includes transmitting, to the portable communication terminals, an information provision request requesting permission to transmit the information provision demand, and transmitting, to the portable communication terminal that has given a reply to an effect that the information provision request is accepted, the information provision demand and information prompting the portable communication terminal to connect to the wireless communication.

### [Supplementary Note 38]

The recording medium according to Supplementary Note 37, further comprising:

controlling wireless communication in each of at least one wireless communication area, wherein

the transmitting includes, when it is determined, during controlling of the wireless communication, that the portable communication terminal has entered the wireless communication area, transmitting the information provision request to the portable communication terminal.

### [Supplementary Note 39]

The recording medium according to Supplementary Note 37, wherein

the transmitting includes, when the anomalous event occurs, transmitting the information provision request to a portable communication terminal being present in the at least one wireless communication area covering the position of occurrence.

### [Supplementary Note 40]

The recording medium according to Supplementary Note 36, further comprising:

conducting an analysis to determine whether an event included in received information including the first information is anomalous or normal and, if the analysis has led to a determination that the event is anomalous, outputting the first information.

### [Supplementary Note 41]

The recording medium according to Supplementary Note 36, wherein

the pinpointing includes pinpointing, from among portable communication terminals being present in the at least one wireless communication area covering the position of occurrence, a terminal to which the information provision demand is to be transmitted.

### [Supplementary Note 42]

The recording medium according to Supplementary Note 41, wherein

the pinpointing includes pinpointing the portable communication terminal to which the information provision demand is to be transmitted, from among the portable communication terminals being present in the at least one wireless communication area covering the position of occurrence and being associated with information for identifying the portable communication terminal that permits the information provision demand to be transmitted, the information for identifying being stored in terminal storage means.

### [Supplementary Note 43]

The recording medium according to Supplementary Note 41, wherein

the pinpointing includes, when there is no portable communication terminal that is present in the at least one wireless communication area covering the position of occurrence and is associated with information for identifying the portable communication terminal that permits the information provision demand to be transmitted, the information for identifying being stored in terminal storage means, transmitting an information provision request requesting permission to transmit the information provision demand to a portable communication terminal being present in the at least one wireless communication area covering the position of occurrence.

### [Supplementary Note 44]

The recording medium according to any one of Supplementary Notes 36 to 39, further comprising:

controlling display of the second information on display means, the second information being received from the portable communication terminal, wherein

the controlling display includes, when a request to perform an operation on one or more pieces of the second information to be displayed is received, transmitting the request to perform an operation to the portable communication terminal that has transmitted the second information.

### [Supplementary Note 45]

The recording medium according to any one of Supplementary Notes 36 to 39, wherein

the transmitting includes transmitting the information provision demand and emergency information that aids in avoiding the anomalous event to the portable communication terminal.

### [Supplementary Note 46]

The recording medium according to any one of Supplementary Notes 37 to 39, wherein

the transmitting includes, when at least either one of the information provision request and the information provision demand is transmitted to the portable communication terminal, transmitting, to the portable communication terminal, information to an effect that an incentive is given by transmitting the second information.

### [Supplementary Note 47]

The recording medium according to Supplementary Note 46, wherein

the incentive is determined in accordance with a length of time that the second information is transmitted.

### [Supplementary Note 48]

The recording medium according to Supplementary Note 46, wherein

the incentive is determined in accordance with a distance from the position of occurrence to the portable communication terminal.

### [Supplementary Note 49]

The recording medium according to Supplementary Note 46, wherein

the incentive is determined in accordance with contents of the second information.

### [Supplementary Note 50]

The recording medium according to Supplementary Note 38, further comprising:

when a reply to an effect that the information provision demand is accepted is received from a portable communication terminal, acquiring information for identifying the portable communication terminal and storing the information in terminal information storage means, wherein

the controlling wireless communication includes, after the reply is received, connecting the portable communication terminal to the wireless communication in the wireless communication area.

### [Supplementary Note 51]

The recording medium according to Supplementary Note 38 or 50, wherein

the wireless communication is wireless LAN communication, and the controlling wireless communication includes controlling an access point for the wireless LAN communication.

### [Supplementary Note 52]

The recording medium according to Supplementary Note 38 or 50, wherein

the wireless communication is mobile communication, and the controlling wireless communication includes controlling a base station for the mobile communication.

### [Supplementary Note 53]

A portable communication terminal that receives, when an anomalous event occurs and the portable communication terminal is present in a specific area including a position of occurrence of the anomalous event, a request to provide second information regarding the occurrence of the anomalous event and the position of occurrence of the anomalous event, and transmits the second information to a source that has requested to provide the second information.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### INDUSTRIAL APPLICABILITY

In the example embodiments described above, wireless LAN communication is mainly used; however, the present invention can also be applied to the case where the wireless communication is mobile communication (4G, for example). In this case, the wireless communication control unit 22 controls a base station for the mobile communication instead of the wireless communication access point 13. As a result, information can be collected from a broad area even when an extensive disaster such as an earthquake or tsunami occurs.

### REFERENCE SIGNS LIST

10 zone surveillance system
11a portable communication terminal
11b portable communication terminal
11c portable communication terminal
11d customer
11e customer
11f customer
12 surveillance camera
13 wireless communication access point
14 intercom apparatus
15 SCCS server
16 OBCS server
20 central control device (surveillance control device)
21 surveillance unit
22 wireless communication control unit
23 CCCS control unit
24 surveillance integration unit
24a first information reception unit
24b event analysis unit
24c identifying information reception unit
24d pinpointing unit
24e transmission unit
24f second information reception unit
24g request unit
25 registered terminal management unit
25a registration management unit
25b terminal information storage unit
26 display control unit
27 display unit
28 event storage unit
29 zone information storage unit
31 camera unit
32 input/output unit
33 microphone unit
34 communication unit
35 control unit
36 storage unit
100 surveillance system
200 surveillance control device (central control device)
201 first information reception unit
202 identifying information reception unit
203 pinpointing unit
204 transmission unit
205 second information reception unit
500 information processing device
504 program
505 storage device
506 recording medium
507 drive device
508 communication interface
509 communication network
510 input/output interface
511 bus

What is claimed is:

1. A surveillance control device comprising one or more memories storing instructions and one or more processors configured to execute the instructions to:
receive first information regarding occurrence of an anomalous event and a position of occurrence of the anomalous event;
receive, through wireless communication, information for identifying one or more portable communication terminals being present in a specific area including the position of occurrence;
pinpoint, from among the portable communication terminals and based on the position of occurrence and the information for identifying, a portable communication terminal to which an information provision demand regarding the position of occurrence is to be transmitted;
transmit the information provision demand to the portable communication terminal; and
receive, from the portable communication terminal, second information regarding the occurrence of the anomalous event and the position of occurrence of the anomalous event, the second information being related to the information provision demand.

2. The surveillance control device according to claim 1, wherein
the one or more processors are configured to execute the instructions to transmit, to the portable communication terminals, an information provision request requesting permission to transmit the information provision demand, and transmit, to the portable communication terminal that has given a reply to an effect that the information provision request is accepted, the information provision demand and information prompting the portable communication terminal to connect to the wireless communication.

3. The surveillance control device according to claim 2, wherein
the one or more processors are configured to execute the instructions to:
control wireless communication in each of at least one wireless communication area, and
when it is determined that the portable communication terminal has entered the wireless communication area, transmit the information provision request to the portable communication terminal.

4. The surveillance control device according to claim 2, wherein
the one or more processors are configured to execute the instructions to, when the anomalous event occurs, transmit the information provision request to a portable communication terminal being present in at least one wireless communication area covering the position of occurrence.

5. The surveillance control device according to claim 1, wherein
the one or more processors are configured to execute the instructions to conduct an analysis to determine whether an event included in received information including the first information is anomalous or normal and, if the analysis has led to a determination that the event is anomalous, output the first information.

6. The surveillance control device according to claim 1, wherein
the one or more processors are configured to execute the instructions to pinpoint, from among portable communication terminals being present in at least one wireless communication area covering the position of occurrence, a terminal to which the information provision demand is to be transmitted.

7. The surveillance control device according to claim 6, wherein
the one or more processors are configured to execute the instructions to pinpoint, from among the portable communication terminals being present in the at least one wireless communication area covering the position of occurrence and being associated with the information for identifying stored in terminal information memory that stores information for identifying the portable communication terminal that permits the information provision demand to be transmitted, the portable communication terminal to which the information provision demand is to be transmitted.

8. The surveillance control device according to claim 6, wherein,
when there is no portable communication terminal that is present in the at least one wireless communication area covering the position of occurrence and is associated with the information for identifying stored in terminal information memory that stores information for identifying the portable communication terminal that permits the information provision demand to be transmitted, the one or more processors are configured to execute the instructions to transmit an information provision request requesting permission to transmit the information provision demand to a portable communication terminal being present in the at least one wireless communication area covering the position of occurrence.

9. The surveillance control device according to claim 1, wherein
the one or more processors are configured to execute the instructions to:
display the received second information on display, and
when a request to perform an operation on one or more pieces of the second information to be displayed is received, transmit the request to perform an operation to the portable communication terminal that has transmitted the second information.

10. The surveillance control device according to claim 1, wherein
the one or more processors are configured to execute the instructions to transmit the information provision demand and emergency information that aids in avoiding the anomalous event to the portable communication terminal.

11. The surveillance control device according to claim 2, wherein
when transmitting at least either one of the information provision request and the information provision demand to the portable communication terminal, the one or more processors are configured to execute the instructions to transmit, to the portable communication terminal, information to an effect that an incentive is given by transmitting the second information.

12. The surveillance control device according to claim 11, wherein
the incentive is determined in accordance with a length of time that the second information is transmitted.

13. The surveillance control device according to claim 11, wherein
the incentive is determined in accordance with a distance from the position of occurrence to the portable communication terminal.

14. The surveillance control device according to claim 11, wherein
the incentive is determined in accordance with contents of the second information.

15. The surveillance control device according to claim 3, wherein
the one or more processors are configured to execute the instructions to:
when a reply to an effect that the information provision demand is accepted is received from a portable communication terminal, acquire information for identifying the portable communication terminal and store the information in terminal information memory, and
after the reply is received, connect the portable communication terminal to the wireless communication in the wireless communication area.

16. The surveillance control device according to claim 3,
wherein the wireless communication is wireless LAN communication, and
wherein the one or more processors are configured to execute the instructions to control an access point for the wireless LAN communication.

17. The surveillance control device according to claim 3,
wherein the wireless communication is mobile communication, and
wherein the one or more processors are configured to execute the instructions to the control a base station for the mobile communication.

18. A surveillance system comprising:
the surveillance control device according to claim 1;
a zone surveillance system that is disposed in each of surveillance zones and is communicably connected to the surveillance control device; and
a portable communication terminal that is held by a customer present in each of the surveillance zones and is capable of taking an image, wherein
the zone surveillance system comprises at least one of:
a surveillance camera;
a wireless communication connection point; and
an intercom apparatus.

19. A surveillance method comprising:
receiving first information regarding occurrence of an anomalous event and a position of occurrence of the anomalous event;
receiving, through wireless communication, information for identifying one or more portable communication terminals being present in a specific area including the position of occurrence;
pinpointing, from among the portable communication terminals and based on the position of occurrence and the information for identifying, a portable communication terminal to which an information provision demand regarding the position of occurrence is to be transmitted;
transmitting the information provision demand to the portable communication terminal; and
receiving, from the portable communication terminal, second information regarding the occurrence of the anomalous event and the position of occurrence of the anomalous event, the second information being related to the information provision demand.

20. A non-transitory recording medium storing a surveillance program that causes a computer to implement:
receiving first information regarding occurrence of an anomalous event and a position of occurrence of the anomalous event;
receiving, through wireless communication, information for identifying one or more portable communication terminals being present in a specific area including the position of occurrence;
pinpointing, from among the portable communication terminals and based on the position of occurrence and the information for identifying, a portable communication terminal to which an information provision demand regarding the position of occurrence is to be transmitted;
transmitting the information provision demand to the portable communication terminal; and
receiving, from the portable communication terminal, second information regarding the occurrence of the anomalous event and the position of occurrence of the anomalous event, the second information being related to the information provision demand.

21. (canceled)
